(19) United States
(12) Patent Application Publication
(10) Pub. No.: US 2022/0118858 A1
(43) Pub. Date: Apr. 21, 2022

(54) Magnetically Powered Vehicle and Electromagnetic Roadway

(71) Applicant: Rachel Lisa Rieger, Escondido, CA (US)

(72) Inventor: Rachel Lisa Rieger, Escondido, CA (US)

(21) Appl. No.: 17/497,395

(22) Filed: Oct. 8, 2021

Related U.S. Application Data
(60) Provisional application No. 63/093,812, filed on Oct. 20, 2020.

(51) Int. Cl. B60L 13/10; B60L 13/04; B61B 13/08

(52) U.S. Cl. CPC B60L 13/10; B61B 13/08; B60L 13/04

(57) ABSTRACT

This invention powers road transportation vehicles with an electromagnetic roadway by means of magnetic propulsion. The vehicle contains an on-board magnet, and the roadway contains an array of electromagnets and an electrical power source. The vehicle is propelled in motion by the interaction between the vehicles on-board magnet and the activated electromagnets in the roadway. The electromagnets in the roadway are normally idle, and only activate when a vehicle signals that it is in range. Sequential electromagnetic activation can be viewed as electromagnetic pulses along the path of the vehicle in motion. The energy to activate the electromagnets can come from a rechargeable power source that can be charged via solar, making it very energy conscious.

### CROSS-REFERENCE TO RELATED APPLICATIONS

Provisional Patent Application No. 63/093,812
Provisional Patent Filing Date: Oct. 20, 2020

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

This invention relates generally to road transportation systems and, more particularly, to a magnetic propulsion system.

Road transportation vehicles are used to transport humans and goods from one location to another via a roadway. Conventional road transportation vehicles today contain an on-board mechanical propulsion system, such as a gas powered engine and/or electric powered motor, and on-board power sources, such as fuel and/or batteries. These on-board mechanical propulsion systems and power sources are typically heavy, which in turn make them costly and energy demanding to propel their own weight. Worldwide, nations are looking for more sustainable road transportation technologies to reduce the carbon footprint as the need for road transportation vehicles increases with the rising human population.

On-board mechanical propulsion systems and power sources can catch fire and explode in an accident, making them potentially dangerous to operate.

Conventional on-board power sources must be replenished on a recurring basis with fuel and/or electricity. Recharging electric vehicles can take a considerable amount of time and be inconvenient to the user. New technologies, such as rapid charging stations and wireless charging roadways, are being developed worldwide to reduce the time needed to recharge electric vehicles.

### BRIEF SUMMARY OF THE INVENTION

In this disclosure, a novel concept is proposed that allows an electromagnetic roadway to magnetically propel road transportation vehicles driving on it. Each vehicle contains one or more on-board magnets that interact with an array of electromagnets embedded in the roadway.

The electromagnetic roadway exists in a deactivated state until a vehicle sends a signal to activate it. The signal sent from the vehicle to the road can be accomplished with several technologies, such as inductively, optically, magnetically, RF (Blue Tooth, etc.), acoustically, and more. The signal activates only the electromagnets embedded in the roadway that are in within a certain range of the vehicle. This periodic activation makes the system consume only the energy it requires with minimal waste.

Once an electromagnet in the roadway is activated, it creates a magnetic field that extends into the vicinity of the vehicle on the roadway. The interaction between the electromagnetic field generated by the roadway and the magnet on the vehicle propels the vehicle in motion. Adjacent electromagnets in the array become activated as the vehicle moves along the roadway allowing continuous vehicle motion. The array of electromagnets, combined with a steering system and free wheels, allows the vehicle to move along the two-dimensional roadway with the same freedom as a conventional vehicle.

The system can be powered by the electrical grid or by a rechargeable power source integrated with the roadway and can be smart charged via solar, making it highly energy efficient. The vehicle operates without refueling or recharging, and maintains a high level of safety even in an accident because the power source is integrated into the roadway. The vehicle is light weight with no on-board mechanical propulsion system or power source for propulsion, making it simple and economical to produce, and less energy demanding.

### BRIEF DESCRIPTION OF THE SEVERAL VIEWS OF THE DRAWINGS

FIG. 1A is an iso top view of the electromagnetic roadway that contains a plurality of electromagnetic modules arranged in an array according to the embodiments of this disclosure.

FIG. 1B is a side view of a single electromagnetic module according to the embodiments of this disclosure.

FIG. 2 is a an iso top view of the magnetically powered vehicle in contact with the electromagnetic roadway according to the embodiments of this disclosure.

FIG. 3 is a side view of the magnetically powered vehicle and electromagnetic roadway with a single activated electromagnet. Forward motion of the vehicle is accomplished by the activated electromagnet as described according to the embodiments of this disclosure.

FIG. 4 is a flowchart that illustrates the signaling pathway for the vehicle to communicate its request for, and receive, power according to the embodiments of this disclosure.

### DETAIL DESCRIPTION OF THE INVENTION

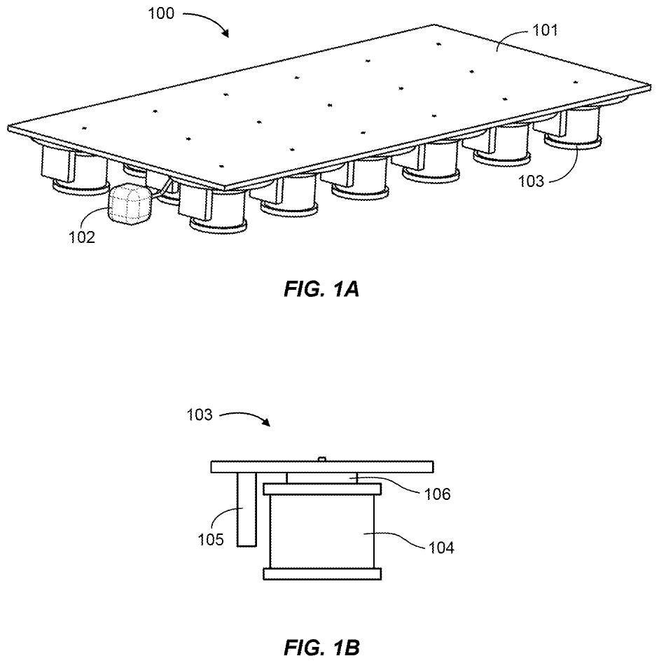

The electromagnetic roadway 100 consists of a roadway 101, an electrical power source 102, and a plurality of embedded electromagnetic modules 103 arranged in an array as shown in FIG. 1A. An electromagnetic module 103 consists of an individual electromagnet 104 switched ON by an electromagnetic driver 105 and controlled by a remote activation receiver 106 as shown in FIG. 1B.

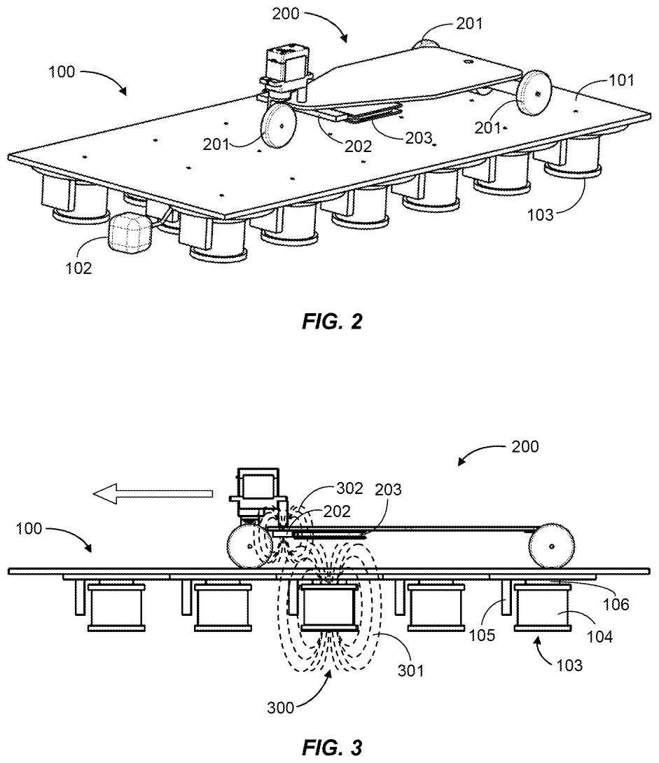

The magnetically powered vehicle 200 sits on top of the electromagnetic roadway 100. The vehicle 200 consists of free wheels 201, one or more on-board magnets 202 (permanent magnet or magnetic block) and remote electromagnetic activators 203 as shown in FIG. 2. The vehicles free wheels 201 are used only for steering, and are not powered by any force.

Each electromagnet 104, within its respective electromagnetic module 103, remains in a deactivated state until it receives a signal and is turned ON into an activated state. The vehicle 200 is propelled in motion by attraction and/or repulsion forces between the on-board magnet 202 and an activated electromagnet 300 in the electromagnetic roadway 100 as shown in FIG. 3. All remaining electromagnets 104 in the electromagnetic roadway 100 are deactivated until they are activated.

When the remote electromagnetic activator 203 aligns accordingly with a remote activation receiver 106, a signal is transmitted from the remote electromagnetic activator 203 on the vehicle 200 to the remote activation receiver 106 in the electromagnetic roadway 100. When the remote activation receiver 106 receives this signal, it activates the electromagnetic driver 105, which switches ON the activated electromagnet 300. An activated electromagnet 300 produces an electromagnetic field 301 as shown in FIG. 3. This electromagnetic field 301 interacts with the magnetic field 302 of the vehicles on-board magnet 202 to produce the force which propels the vehicle 200 in motion. The interaction of the vehicle's magnetic field 302 and the roadway's electromagnetic field 301 generates the force to propel the vehicle 200 in motion relative to the electromagnetic roadway 100 due to attraction and/or repulsion as shown in FIG. 3.

When a vehicle 200 with corresponding on-board magnet 202 and remote electromagnetic activator 203 are in range of an electromagnetic module 103, the vehicle 200 is propelled in motion until it exits the range of the electromagnetic module 103. The array, or geometric arrangement, of the electromagnetic modules 103 ensure that the vehicle 200 is always in range of an electromagnetic module 103 to propel it. When the vehicle 200 exits the range of one electromagnetic module 103, it enters the range of an adjacent electromagnetic module 103. The activated electromagnets 300 are turned ON sequentially to always provide power to the vehicle 200 for motion when in range, and to save power when there is no vehicle 200 in range. This sequential activation can be viewed as electromagnetic pulses along the path of the vehicle 200 in motion.

The vehicle's direction is controlled by the vehicle operator (human or software). The vehicle 200 is free to move in any direction on the plane that is the electromagnetic roadway 100 by a steering system that controls the angle of the free wheels 201.

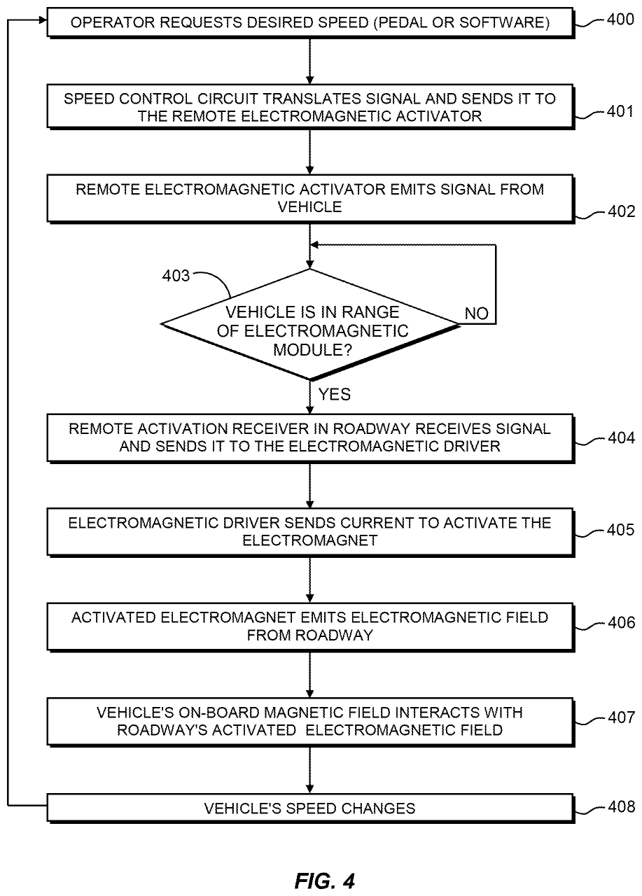

The signaling pathway that allows the operator to control the vehicle's speed by requesting power from the electromagnetic roadway 100 is demonstrated with a flowchart in FIG. 4 in conjunction with FIG. 3. The vehicle's speed is controlled by the vehicle operator (human or software). The vehicle operator controls the speed of the vehicle by requesting the desired speed via the accelerator pedal and/or software (step 400) to a speed control circuit. The speed control circuit then translates this into a signal that the remote electromagnetic activator 203 can interpret, and sends the translated signal to the remote electromagnetic activator 203 (step 401). The remote electromagnetic activator 203 on the vehicle 200 then constantly emits this signal (step 402), regardless of if it is on the electromagnetic roadway 100. This signal is transmitted from the vehicle 200 to the electromagnetic roadway 100 only when the vehicle 200 emitting a signal via the remote electromagnetic activator 203 is in range of an electromagnetic module 103 in the electromagnetic roadway 100 (step 403). When in range, the remote activation receiver 106 receives the signal emitted from the remote electromagnetic activator 203 and sends it to the electromagnetic driver 105 (step 404). The electromagnetic driver 105 computes how much current to send the electromagnet 104 and sends that current, which converts the deactivated electromagnet 104 into an activated electromagnet 300 (step 405). The activated electromagnet 300 emits an electromagnetic field 301 which radiates from the electromagnetic roadway 100 into the range of the vehicle 200 (step 406). The vehicle's on-board magnet 202 and corresponding magnetic field 302 interacts with the electromagnetic field 301 generated by the electromagnetic roadway 100 (step 407). The attraction and/or repulsion of these two magnetic fields 301,302 controls the amount of power that the vehicle 200 receives from the electromagnetic roadway 100 and changes the vehicles speed accordingly (step 408).

The stronger the electromagnetic field strength is, the stronger the interaction between the electromagnetic field 302 and the magnetic field 301 is, and the more force is generated to propel the vehicle 200 in motion. Although the vehicle 200 controls its own speed, the strength of the electromagnetic field 301 emitted by the electromagnetic roadway 100 will have a saturation capacity to limit the vehicles 200 to a maximum speed.

Stronger on-board magnets 202 and/or stronger electromagnets 104 can be used to increase the amount of force applied from the electromagnetic roadway 100 to the vehicle 200.

A higher density array of electromagnetic modules 103 in the electromagnetic roadway 100 can be used to increase the amount of force applied from the electromagnetic roadway 100 to the vehicle 200 and/or smooth the ride of the vehicle 200.

Multiple on-board magnets 202 can be used to increase the amount of force applied from the electromagnetic roadway 100 to the vehicle 200 and/or smooth the ride of the vehicle 200.

There are many technologies that can be utilized to transfer the input signal from the remote electromagnetic activator 203, on-board the vehicle 200, to the remote activation receiver 106 in the electromagnetic roadway 100.

An inductive emitting coil can be used as the remote electromagnetic activator 203 and an inductive sensing coil can be used as the remote activation receiver 106. For inductive sensing technology, the type of signal that is emitted from the remote electromagnetic activator 203 and received by the remote activation receiver 106 is a pulse width modulated signal. The pulse width modulated signal can vary from 0 to 100% duty cycle (100% duty cycle for maximum power) to modulate the strength of the electromagnetic field 301 and ultimately the power received by the vehicle 200 from the electromagnetic roadway 100 for speed control. Pulse width modulation has very high efficiency because the signal is either ON or OFF. The electromagnetic driver 105 controls the electromagnet 104 based on two inputs; 1) the presence of the pulse width modulated signal (ON or OFF) controls the activation state of the electromagnet 104 (activated or deactivated, respectively) and 2) the duty cycle of the pulse width modulated signal controls the strength of the activated electromagnet 300.

Other remote sensing technologies can be used such as acoustic/ultrasonic, radiofrequency/Bluetooth, optical, magnetic, etc.

The electromagnetic roadway 100 is equipped with an electrical power source 102 that provides the electrical power needed to energize all components in the electromagnetic roadway 100, especially the electromagnetic modules 103. The electrical power source 102 can be an electrical grid or a dedicated power source. The electrical power source 102 can be rechargeable by solar, wind, or any other appropriate source. Solar panels can be directly integrated as the top layer of the roadway 101. The electrical power source's 102 size and weight is not critical since it is stationary; therefore, any high performance and reliable electrical power source 102 can be used.

The vehicle 200 utilizes the same technology mentioned in this disclosure to move in reverse. There are many ways to move the vehicle 200 in reverse. A reverse pedal can connect to an additional on-board magnet 202 with an orientation that attracts rather than repels (or vice versa) the additional on-board magnet 202 to the activated electromagnet 300. A mechanism can exist in the vehicle that inverts the on-board magnet's 202 orientation to utilize the same magnet for forward and reverse operation. An additional remote electromagnetic activator 203 and/or remote activation receiver 103 can be installed in a location on the vehicle 200 to activate an electromagnet 104 when the electromagnet 104 and on-board magnet 203 are oriented to attract rather than repel (or vice versa) the on-board magnet 202 to the activated electromagnet 300.

This novel technology has a wide range of applications in addition to the conventional use of road transportation vehicles. The magnetically powered vehicle 200 and electromagnetic roadway 100 can also be applied to warehouse vehicles used in the transportation of goods (such as AGV, forklift, etc.), bicycles, scooters, toys, etc.

The magnetically powered vehicle 200 with electromagnetic roadway 100 was successfully reduced to practice (demonstrated on a small scale) using induction, optical, and magnetic remote activation.

1. An electromagnetic roadway that propels a vehicle via magnetic force, compromising:
a roadway surface to support a vehicle on;
an electrical power source;
a plurality of electromagnetic modules arranged in an array, each comprised of an electromagnet that is activated remotely by a vehicle, an electromagnetic driver, and a remote activation receiver that controls the power of the electromagnet.

2. The electromagnetic roadway of claim 1, wherein the electromagnetic power can be varied to control the vehicles speed.

3. The electromagnetic roadway of claim 2, wherein pulse width modulation is used to control the electromagnetic duty cycle from 0% to 100%.

4. The electromagnetic roadway of claim 2, wherein the electrical power source is rechargeable.

5. The electromagnetic roadway of claim 4, wherein the electrical power source is rechargeable via solar.

6. The electromagnetic roadway of claim 5, wherein the roadway surface is compromised of solar panels to charge the electrical power source.

7. The electromagnetic roadway of claim 1, wherein the remote electromagnetic activator is comprised of inductive emitting coils.

8. The electromagnetic roadway of claim 1, wherein the remote electromagnetic activator is comprised of optical emitters.

9. The electromagnetic roadway of claim 1, wherein the remote electromagnetic activator is comprised of magnetic material.

10. The electromagnetic roadway of claim 1, wherein the remote electromagnetic activator is comprised of acoustic/ultrasonic emitters.

11. The electromagnetic roadway of claim 1, wherein the remote electromagnetic activator is comprised of radiofrequency emitters.

12. A vehicle that is propelled via a magnetic force by the electromagnetic roadway of claim 1, comprising:
one or more on-board magnets;
one or more remote electromagnetic activators which remotely activate a nearby electromagnet after being turned ON by an operator;
two or more free wheels which are not powered by any force and used only for steering.

13. The magnetically powered vehicle of claim 12 further compromising a manual drive option to drive off of the electromagnetic roadway.

14. The magnetically powered vehicle of claim 12, wherein the remote activation receiver is comprised of inductive sensing coils.

15. The magnetically powered vehicle of claim 12, wherein the remote activation receiver is comprised of optical receivers.

16. The magnetically powered vehicle of claim 12, wherein the remote activation receiver is comprised of magnetic sensors.

17. The magnetically powered vehicle of claim 12, wherein the remote activation receiver is comprised of acoustic/ultrasonic receivers.

18. The magnetically powered vehicle of claim 12, wherein the remote activation receiver is comprised of radiofrequency receivers.
